(19) United States
(12) Patent Application Publication
(10) Pub. No.: US 2006/0043170 A1
(43) Pub. Date: Mar. 2, 2006

(54) Personal account protection system

(76) Inventor: Howard Clinton Weaver, Kentwood, MI (US)

Correspondence Address: Howard Clinton Weaver, 2309 Bridle Creek St., SE, Kentwood, MI, 49509, US

(21) Appl. No.: 10/932,644

(22) Filed: Sep. 2, 2004

(51) Int. Cl. G06K 5/00

(52) U.S. Cl. 235/380

(57) ABSTRACT

The “Personal Account Protection System” allows the use of personal identification numbers (PIN)s on magnetized monetary transaction cards without allowing those (PIN)s to leave the checkout counter card-swipe/keypad unit. Also, the (PIN)s are ERASED from the units themselves when the transactions are complete. In other words, the (PIN)s never follow the final transaction. If a card is lost or stolen, it is essentially worthless to anyone else. The system should save card issuers and users millions of dollars lost per year.

### BACKGROUND OF THE INVENTION

I have a debit card that was issued by a local supermarket chain. I swipe the card at checkout and press in my 4 digit PIN and the ENTER key on the keypad. I obtain a receipt that the billing amount will be electronically withdrawn from my checking account. An important feature is that the card can't be used by anyone else if it is ever lost or stolen.

I also have 2 national credit cards that don't have a PIN to protect me against loss either. I imagine they hesitated to use that feature due to the massive cost and effort required to change their accounting system to accommodate millions of PIN's. Also, if the list of account numbers and their personal numbers should be lost or stolen, the cost for card issuers and users would be enormous.

### SUMMARY OF THE INVENTION

I have devised a system that would require a card issuer to do very little to implement a PIN safety feature for their account customers. The system will BLOCK the transaction instead of ALLOWING it at the checkout if the PIN is entered incorrectly.

### DESCRIPTION OF THE INVENTION: AS FOLLOWS

1. The card issuer announces that a new protective card is available for current card users if they send back the enclosed form signed and include a chosen PIN with their current bill payment.
2. Their current account numbers (CAN) will remain the same. The issuer will add a letter (P) in front or rear of all the (CAN)s that identifies that they are identity protected.
3. The issuer sends a new protective card having (P)(CAN) on the front of the card. The user signs on the back as usual.
4. The magnetized metal strip contains the (PIN)(P)(CAN) and other usual information.
5. At the checkout the user swipes the card thru the keypad slot. This installs the (PIN) that BLOCKS the (P)(CAN) from leaving the keypad.
6. The user then presses their (PIN) in the proper sequence and presses the (ENTER) key. This DELETES the (PIN) and allows the (P)(CAN) to be processed as usual to the card center. If the (PIN) is NOT entered correctly, the transaction DENIED at the checkout.
7. Note that the (PIN) is DELETED in this system and never goes beyond the keypad. It disappears.

### EDUCATIONAL TIMELINE

1930: Born, Grand Rapids, Mich.
1948: East Lansing High School, graduated with honors
1949: Michigan State University, Freshman
1950: University of Michigan, five year School of Architecture
1951: U.S. NAVY, PATUXENT RIVER, Md. four years as a Draftsman
1955: University of Michigan, continued architectural education
1959: Graduated with B.A. in architecture
1959-1970: Lansing, Mich., apprentice in architecture
1971: Registered:Architect
1978: Registered Real Estate Broker, Grand Rapids, Mich.
1986: Received CCIM certification as REALTOR
2000: Retired Architect & REALTOR, CCIM Grand Rapids, Mich.

1. I can't imagine of an easier, more cost effective way for monetary transaction card companies and their users to deter the crooks and thieves from stealing millions of dollars annualy. It will make lost or stolen card essentially worthless to the bad guys. The (PIN)(P)(CAN) system can be easily contained in a micro-chip and installed in existing card/swipe keypads. The P.A.P.S. of ENTER/DELETE (PIN)s ensures PERSONAL IDENTIFICATION NUMBERS never leave the keypad.
